(19) United States
(12) Patent Application Publication
(10) Pub. No.: US 2010/0011760 A1
(43) Pub. Date: Jan. 21, 2010

(54) Hydraulic heat engine utilizing heat of compression and having independent control loop

(76) Inventor: Daniel Charles Scampini, Cottonwood, CA (US)

Correspondence Address: Daniel Charles Scampini, PO Box 1822, Cottonwood, CA, 96022, US

(21) Appl. No.: 12/229,704

(22) Filed: Aug. 25, 2008

Related U.S. Application Data
(60) Provisional application No. 60/965,846, filed on Aug. 23, 2007.

(51) Int. Cl. F02G 1/04

(52) U.S. Cl. 60/520; 60/526

(57) ABSTRACT

A high performance modular heat engine is presented that uses a highly pressurized working gas and hydraulic fluid within a pipeline or flow circuit to produce power hydraulically. It does this by adding heat to the working gas via a control loop, isolated from the power producing working gas and hydraulic fluid, to increase its pressure and impart movement to said hydraulic fluid. The heat engine can utilizes its working gas' heat of compression to improve its performance by removing it during compression and returning it to the working gas during expansion. The engine can use momentum developed internally to convert low temperature heat into high temperature heat to boost its efficiency and performance by creating an artificial high ΔT between its heat source and heat sink.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates in general to heat engines that utilize an external heat source such as solar, geothermal, combustion, waste heat etc., to produce work for driving generators or producing electricity otherwise, driving pumps, driving shafts etc., and for producing heating and cooling. This field of energy production has become more attractive with ever-rising fuel prices and concerns for emissions and global warming. However, these engines are still not attractive enough an option to be taken seriously as a replacement for the internal combustion engine in just about all applications. This is due to the fact that all but the most expensive, exotic designs waste a tremendous amount of heat since it is very difficult for these types of engines to efficiently utilize a heat source. These heat engines require a very large ΔT between their heat sources and their heat sinks to run efficiently, requiring exotic materials and complex designing, rendering them more of a novelty of design, rather than engines of practical use. In addition, they require massive heat exchangers to transfer heat necessary for efficient operation, making them cumbersome, heavy, and expensive. If a heat engine could be developed that could solve one or more of these disadvantages or lessen the extent thereof, then it could be much more competitive in today's market.

### BRIEF SUMMARY OF THE INVENTION

The present invention overcomes these limitations by being relatively inexpensive to build and maintain using conventional readily-available components, that can efficiently utilize not only large ΔT's between its heat source and heat sink, but also minor ones, and that doesn't require the massive expensive heat exchangers of conventional heat engines, to make it a much more attractive alternative to internal combustion engines, as well as an excellent choice for eco-fuel and solar energy production.

The present invention is a high performance modular heat engine that utilizes a highly pressurized working gas (defined as gas over 100 psi prior to engine startup) and hydraulic fluid within a pipeline, tube or flow circuit to produce power hydraulically or otherwise. It does this by adding heat to the high pressure working gas from a heat source via a control loop, isolated from the working gas and hydraulic fluid, to increase the working gas' pressure and impart movement to the hydraulic fluid, acting as a piston. This propels the piston down through the pipe or tube, further compressing the already highly pressurized working gas ahead of it and generating high compressive temperatures as a result. This is the first half of the engine's operation cycle, during which, heat is extracted from compressing the gas (its heat of compression or HOC) and temporarily stored in the control loop for use in the coming second half of the engine's cycle. This extraction of the working gas' HOC allows for isothermal compression of the working gas. When the piston reaches the end of the piston pipe or tube, the heat source once again adds heat to the isothermally compressed working gas via the control loop, as well as the stored HOC to raise the working gas' pressure and propel the piston back the opposite direction. Heat is continually supplied by the control loop to the working gas behind the piston during its expansion so that it remains isothermal, while simultaneously extracting the HOC ahead of the piston within the pipe or tube so that its compression remains isothermal. Once again, when the piston reaches the end of the pipe or tube, heat from the heat source and the prior cycle's HOC is added to the isothermally compressed working gas just the same as described in the previous cycle, to propel the piston back again in the initial direction. This cycle repeats back an forth through the piston pipe or tube forming the continuous operation of the engine. The control loop's role in all of this is that it is an independent liquid flow loop, out of direct contact with the engine's working gas, that controls the operation of the engine's cycle. It connects fluid-filled heat exchangers within each end of the piston's pipe or tube to similar heat exchangers for both the heat source and the heat sink, so that heat may be transported from the heat source to the piston's pipe or tube, or from the piston's pipe or tube to the heat sink, simply by circulating liquid flow from one to the other. The control loop resides outside the piston's tube and may be an open or closed system. Closed systems have the advantage of being able to operate at any pressure, while open systems (open to the environment) can easily accommodate very large systems. The control loop also controls the extraction and re-addition of HOC to and from the piston's pipe or tube during compression and expansion to maintain isothermal conditions. The advantage of having a highly pressurized working gas within the piston's pipe or tube (up to tens of thousands of psi) is that even relatively small temperature rises in a highly pressurized gas produces significant rises in pressure. Inversely, even relatively minor compression ratios in such highly pressurized gas produces significant rises in temperature. Combine the two and you have the ability in the present invention to utilize even minimal heat sources to impart significant useful energy into the engine's piston to convert high or low temperature working gas propelling the piston on one side, into much higher temperature working gas being generated on the other. This high temperature working gas created is very useful in heat engines and can greatly boost the present invention's efficiency and power output over conventional heat engines. The present invention uses this ability to produce large amounts of usable energy within its working gas from not only the hard to produce large ΔT's (hundreds to thousands of degrees) between its heat source and heat sink that conventional heat engines need to operate efficiently, but also minor ones (tens of degrees) that are readily available anywhere such as solar, or even ambient air. An advantage of the present invention over conventional heat engines in its ability to extract and return the HOC produced during the engine's operation is that this is heat normally discarded as waste by conventional heat engines but is a very important source of heat for the present invention that not only boosts its efficiency, but allows the conversion of normally useless low-grade heat to very useful high grade heat. HOC temperatures can rise very high, even above those of a heat engine's high temperature heat source, producing an artificial “peak” operating temperature. For example, the present invention has the ability to utilize a heat source and heat sink having a low ΔT in that by using the available energy within a low ΔT heat source to initially propel its piston, it can ultimately produce through its HOC, high temperatures and a resultant high ΔT engine operating cycle.

To understand all this better, let's take a quick look at the example provided in the drawings. At quick glance the engine looks like a industrial piping system, and rightfully so since this is just one way the engine can be built, having the same simplicity and flexibility of being able to route the flow paths of its working gas and hydraulic piston, as well as its control loop fluid in virtually any direction to follow a designer's preferred layout. The engine example as it is presented in the diagrams, utilizes water and air as its hydraulic fluid piston and high pressure working gas respectively, and is provided for conveying the general concept of the engine only, since numerous designs are possible, ranging from applications for utility power generation whereby the high-pressure piping may span several hundred yards, to that of powering laptop computers whereby the high-pressure piping is replaced by a micro-sized hydraulic circuit. This engine example illustrated here is made up of a long length of high-pressure pipe, having an air-filled pressure vessel on each end. Water that will act as the engine's piston, and twin hydraulic motors for extracting work, and check valves lie inbetween the two ends of the piping. The hydraulic motors and check valves can be replaced with any variety of commercial or otherwise hydraulic power take-off scenarios. A low pressure liquid-filled “control loop” is made up of a coiled tubing-style heat exchanger positioned within each air-filled pressure vessel, a heater coil tubing-style heat exchanger/heat source combination, and a cooling coil tubing-style heat exchanger/cooling fan “heat sink” combination. Also part of the control loop is a circulation pump connected to, and positioned between the twin heat exchangers, to control the input and output of heat through the air within the high-pressure piping. The section of the control loop spanning between the top of each heat exchanger within the pressure vessels and the heat source represents the regenerator of the engine (not to scale) and serves to extract heat from, and return heat to, the working gas within the pressure vessel during engine operation. A high-pressure hydraulic priming pump exists along the high pressure piping and serves to initially pressurize the working gas (for this example “Air”) hydraulically to very high pressure (several thousand psi) prior to its startup by pumping hydraulic fluid (for this example “water”) into the high pressure piping, compressing it. This is practical for large systems such as those used in utility power generation, although small engines can use a permanently sealed high-pressure gas. So now the working gas is pre-pressurized via the priming pump to several thousand psi. After this is done, heat from the heat source (a high temperature solar collector for this example) is applied to the heating coils of the control loop while a fan blows over the cooling coils of the control loop on the opposite side to maintain a low temperature there. Once the circulation pump is turned on the hot liquid from the control loop heating coils is circulated through the heat exchanger within the first pressure vessel, heating up the working gas and raising its pressure, while the cool liquid from the cooling coils is circulated through the heat exchanger within the second pressure vessel maintaining the working gas there at a minimum temperature and pressure. The flow of liquid through the control loop oscillates back and forth through its own tubing and that of the heat exchangers but never completely around, so that the cool liquid always remains on the cool side of the control loop and the hot liquid always remains on the hot side of the control loop. The high pressure working gas of the first pressure vessel seeks to travel to the relatively low pressure working gas of the second pressure vessel, moving all of the hydraulic fluid (the piston) existing between them along the way as it does. As this happens, the working gas of the second pressure vessel is compressed while its heat of compression is extracted by the cool liquid of the control loop. This extracted heat is not wasted and will be later returned to the working gas for performing work. This movement of hydraulic fluid operates one of the hydraulic motors (a single motor may be used in lieu of the twin presented here) within the flow path, performing work on an external generator. This is the engine's initial power stroke. When the maximum compression is reached within the second pressure vessel's working gas, the circulation motor is reversed, causing the flow within the control loop to travel in the opposite direction. This now circulates the hot liquid of the heating coils through the heat exchanger of the second pressure vessel, heating up the working gas and raising its pressure, while circulating the cool liquid of the cooling coils through the heat exchanger of the first pressure vessel, maintaining the working gas there at a minimum temperature and pressure. Once again, the high pressure working gas tries to seek a path to the relatively low pressure working gas, this time in the direction from the second pressure vessel to the first, pushing the hydraulic liquid between them in the opposite direction and operating the second hydraulic motor within its flow path, and also performing work on the external generator. This is the engine's return power stroke. Like with the engine's initial power stroke, when the maximum compression is reached within the first pressure vessel's working gas, the control loop's circulation motor is reversed, causing the flow within the control loop to travel in the opposite direction with the hot liquid going to the first pressure vessel's working gas and the cool liquid going to the second pressure vessel's gas, and the cycle then repeats itself continuously as the operation cycle of the engine.

### BRIEF DESCRIPTION OF THE SEVERAL VIEWS OF THE DRAWING

FIG. 1 is a diagram of one embodiment of the present invention using solar heat as its heat source, in a shut down ambient state.

FIG. 2 is a diagram of the same embodiment prior to startup where its working gas is being hydraulically pressurized.

FIG. 3 is a diagram of the same embodiment during its initial power stroke.

FIG. 4 is a diagram of the same embodiment whereby the liquid flow within the engine's control loop is reversed prior to the start of its return power stroke.

FIG. 5 is a diagram of the same embodiment during its return power stroke.

### DETAILED DESCRIPTION OF THE INVENTION

This example utilizes solar heat to generate power although any heat source such as combustion, nuclear, waste heat etc. may be substituted in its place and its piping layout may take virtually any form from vertical to horizontal, from smaller than an inch to several hundred yards or more. All of its other parameters such as working gas and hydraulic fluid may also be varied to suit a given application.

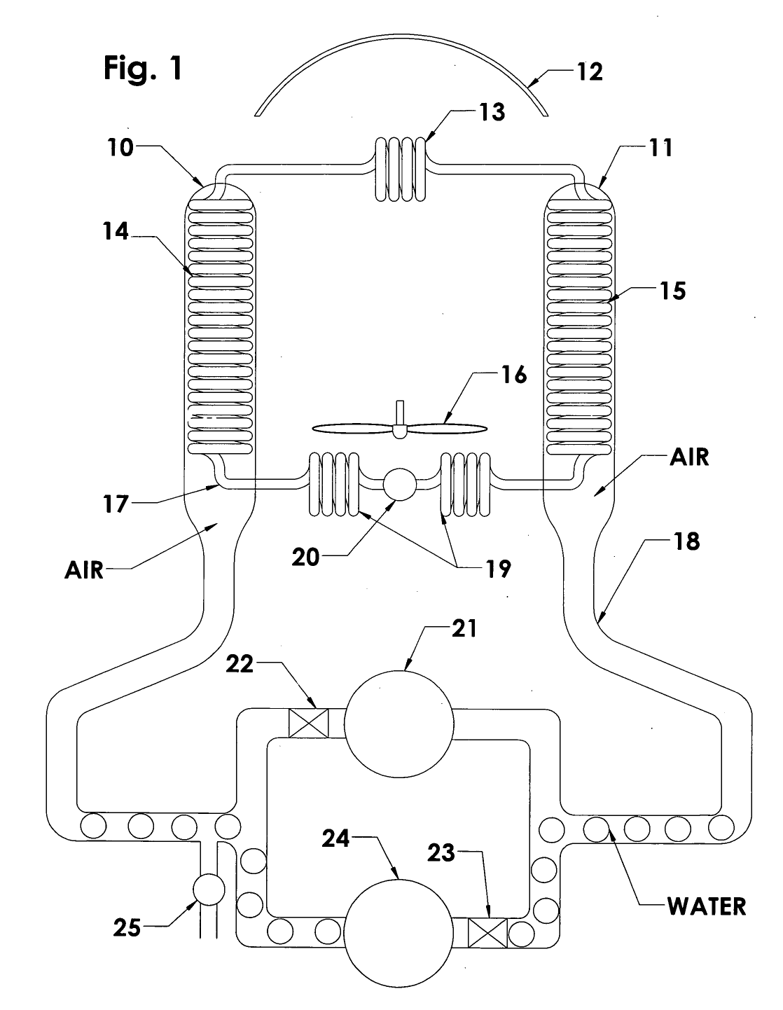

Referring to FIG. 1, with the engine shut down water rests within the bottom high-pressure piping 18 and hydraulic motors 21 & 24. Air fills the upper portion of the high pressure piping as well as both pressure vessels 10 & 11. Oil completely fills the low pressure control loop made up of the heating coil 13 heated via a solar collector 12, cooling coils 19 cooled via a fan 16, a fractional hp circulation pump 20, heat exchangers 14 & 15 and low pressure piping 17 connecting them all together. The entire engine system is unpressurized at ambient temperature.

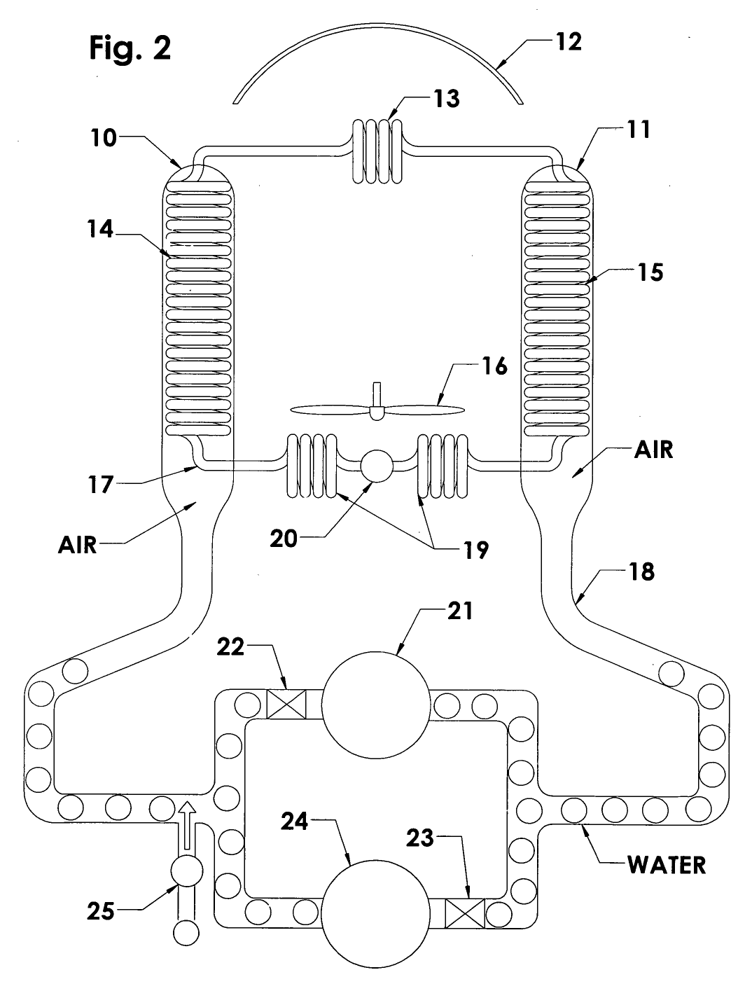

Referring to FIG. 2, the pressurizing pump 25 is turned on which pumps external water into the high pressure piping 18, raising its level and compressing the air above it. The pump 25 continues until reaching the engine's operating pressure of several thousand psi. The pump 25 is turned off and will not be used again until the engine will need to be started up again in the future. At the control loop, solar energy is continually focused on the heating coils 13, heating the oil inside while the battery-operated fan 16 is switched and left on, cooling the oil inside the cooling coils 19.

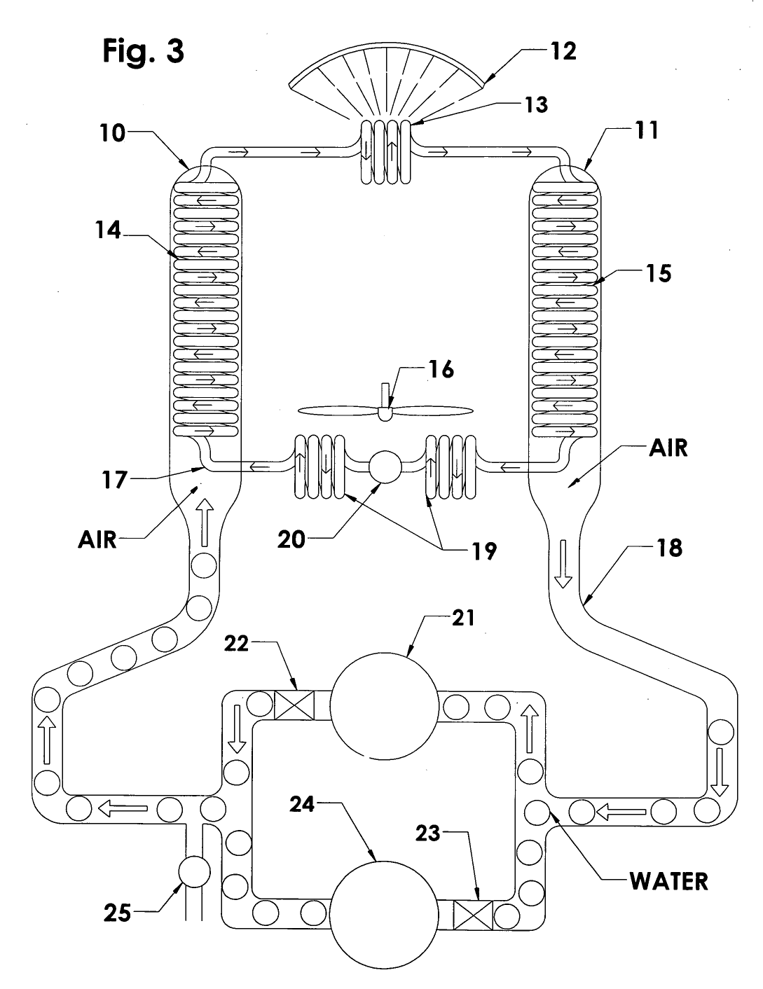

Referring to FIG. 3, when the heating coils 13 reach the desired temperature a thermocouple switches on the battery-operated circulation pump 20 causing the oil within the control loop to flow clockwise. As this happens the hot oil from the heating coils 13 flows through the coils of heat exchanger 15 while the cool oil from the cooling coils 19 flows through the coils of heat exchanger 14. The hot oil entering heat exchanger 15 heats the high pressure air within the surrounding pressure vessel 11 raising the air's pressure while the cool oil entering heat exchanger 14 cools the high pressure air within its surrounding pressure vessel 10 keeping temperature and pressure to a minimum. The flow of oil from the control loop never travels past the opposite end of the heat exchangers 14 & 15 so that the hot oil never reaches the cooling coils 19 and the cool oil never reaches the heating coils 13. The rising air pressure in pressure vessel 11 pushes against the water piston in the high pressure piping 18 below it, forcing it clockwise through the piping as it seeks the lower pressure air of the pressure vessel 10, creating the engine's initial power stroke. The water piston flows through the upper hydraulic motor 21 which can be of any variety (piston, rotary, turbine etc.) that in-turn, turns a generator for recharging the control loop battery and providing external power, but is prevented from passing through the lower motor 24 due to the one-way check valve 23 in front of it. A single hydraulic motor equipped with a directional switching valve could replace the twin motors 21 & 24 presented here. The water continues to flow towards pressure vessel 10, compressing further its already highly pre-pressurized air while it is simultaneously cooled via the cool oil circulating through heat exchanger 14 from the cooling coils 19 of the control loop so that its compression is isothermal. Heat of compression developed within the air is removed via the heat exchanger 14 and serves to pre-heat oil that will be later return to the same air of pressure vessel 10 during the engine's return power stroke. This HOC is temporarily stored within the control loop piping existing between the heat exchanger 14 and the heating coils 13.

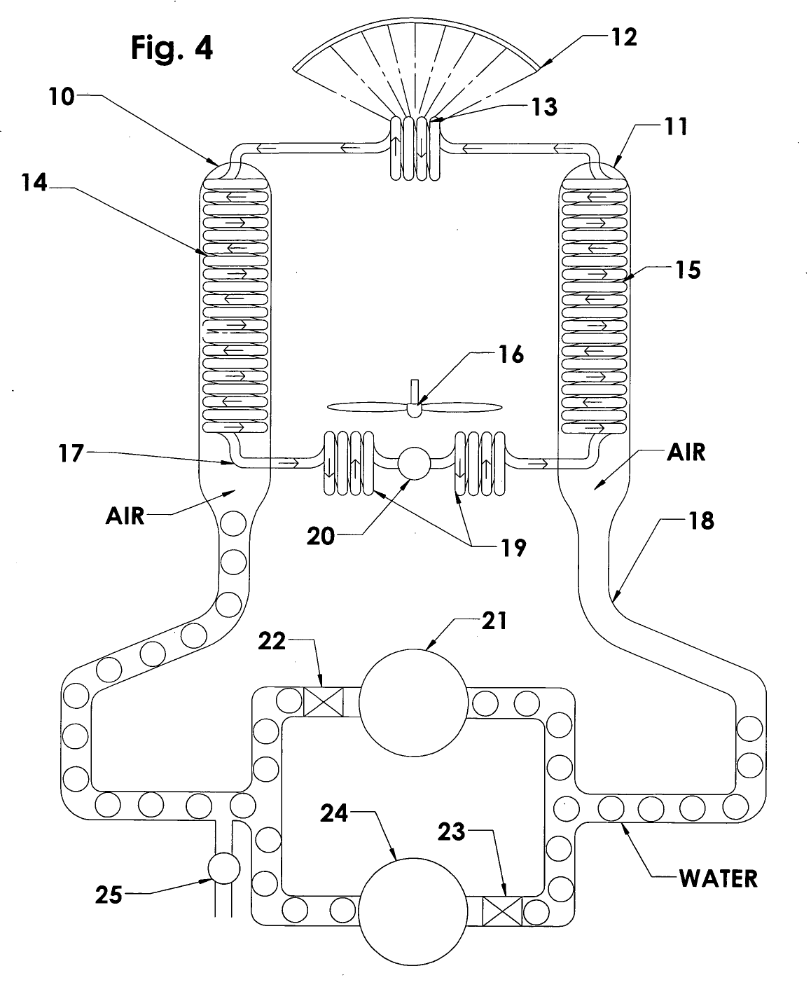

Referring to FIG. 4, when the water level rises to its maximum height within the high pressure piping 18 below pressure vessel 10 that coincides with the maximum pressure attained within the pressure vessel 10 (the water level never reaches as high as the heat exchanger 14), either a water level switch or a pressure switch within the high pressure piping 18 below pressure vessel 10 is activated. This switches the direction of the control loop's circulation motor 20 and in-turn switches the direction of flow through the control loop to counter-clockwise. The reversal of flow within the control loop causes the extremely hot oil within the heating coils 13 to flow to the coils of the heat exchanger 14, preceded by the hot oil possessing the heat of compression given off by the air as it was being isothermally compressed during the first power stroke, that had just left the upper coils of the heat exchanger 14 and was stored between it and the heating coils 13 when the flow through the control loop was clockwise. The hot oil entering the heat exchanger 14 from the top pushes the existing cooler oil within the heat exchanger (since it has given up heat to the air), out through its bottom and back to the cooling coils 19 of the control loop where any remaining heat can be removed so that once fully cooled, it can be used in the next power stroke. This remaining heat is “waste heat” and may be used for a variety of purposes such as pre-heating oil leaving the top coils of the heat exchanger 15 on its way to the heating coils 13 that will be used in the next heating cycle, providing heat to the air as it expands isothermally through the high pressure piping 18 by allowing it to flow through coaxial piping surrounding it as it follows the expanding air through it, or for external use such as heating, refrigeration or powering secondary heat engines. To repeat what was just said earlier, the preceding volume of hot oil entering the heat exchanger 14 gives up its heat (the heat of compression absorbed during the first power stroke's isothermal compression of the air within pressure vessel 10) back to the same now highly compressed cooler air, immediately raising its pressure. This preceding volume of hot oil is followed by the extremely hot oil of the control loop's heating coils 13 that heats and raises the air's pressure to its maximum. In the mean-time the reversal of flow within the control loop has also caused the cool oil that had been sitting within the cooling coils 19 to flow to the coils of the heat exchanger 15, pushing the existing still warm oil out through the top of the heat exchanger and back to the heating coils 13 where it will be further heated for use in the next power stroke. The cool oil entering the heat exchanger 15 cools the hot air within the pressure vessel 11 and reduces its pressure.

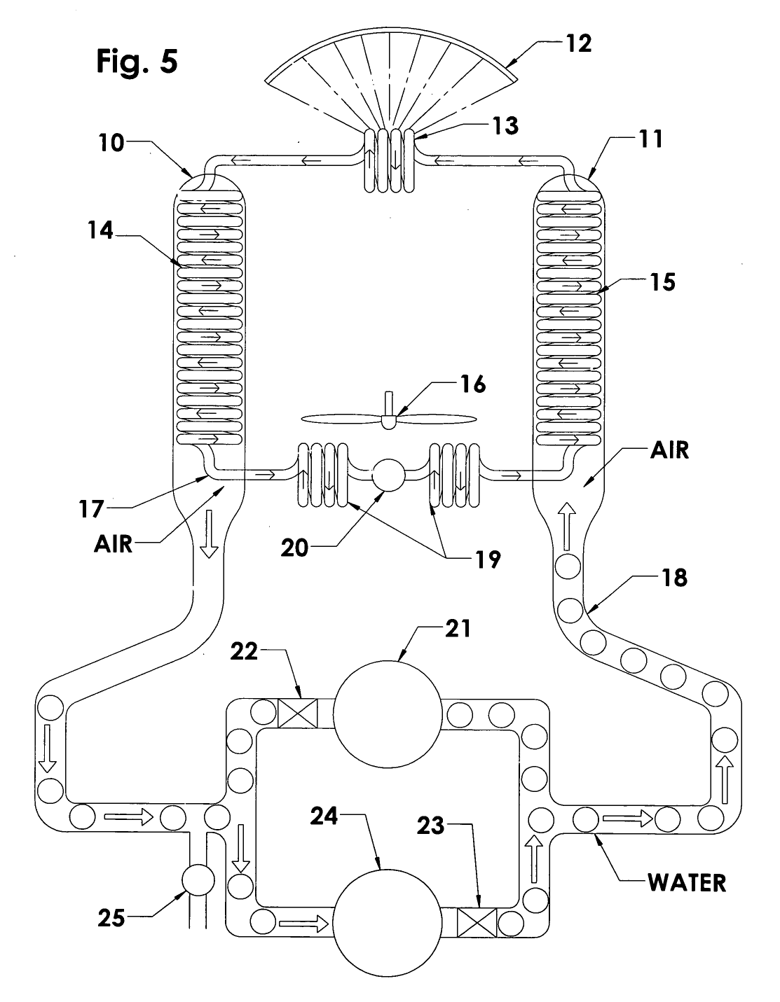

Referring to FIG. 5, now with high pressure hot air in pressure vessel 10 and minimal pressure cool air in pressure vessel 11, the air in pressure vessel 10 pushes against the water in the high pressure piping 18 below it, forcing it counter-clockwise through the piping as it seeks the lower pressure air of the pressure vessel 11, creating the engine's return power stroke. This power stroke is identical to that of the first, just in the opposite direction. The water flows through the lower hydraulic motor 24 turning either a second generator or the same generator as that of the upper hydraulic motor 21, but is prevented from passing through the upper motor 21 due to the one-way check valve 22 in front of it. The water meanwhile compresses the air in pressure vessel 11 isothermally while the cool water of the flow loop passing through heat exchanger 15 absorbs its heat of compression just as in the initial power stroke with pressure vessel 10. Once again, when the maximum air pressure is reached, the control loop is switched via a water level or pressure switch and the cycle repeats itself with the hot oil of the control loop's heating coils 13 flowing back into the heat exchanger 15 of pressure vessel 11 preceded by the heat of compression oil, while the cool oil of the control loop's cooling coils 19 flows back into the 14 heat exchanger of pressure vessel 10.

Considering all other things equal, the longer the length of the initial and return power strokes of the engine, the higher the efficiency of the engine. This is true since much more of the heat inputted into the heating coils is utilized for expanding the working gas and performing work before being lost during the switching of the control loop's direction, whereby thermal losses occur each time cool oil replaces hot oil in the heat exchangers and vice-versa, and heat is added and removed from the working gas.

It would not be uncommon to have a municipal power station having its high-pressure piping extending several hundred yards, permitting the hydraulic fluid to travel over the span of several minutes through the hydraulic motor(s) between each initial and return power stroke. Obviously there are practical limits to how long a pipeline can extend before factors such as losses due to internal friction become overwhelming. In addition, the momentum of the water column within the high pressure piping plays an important factor in the level to which the working gas within the pressure vessels can be compressed. For example, a column of water traveling through the high pressure piping at a fast speed will impart more energy into the air within the pressure vessels than the same column of water traveling at a slow speed, and a long column of water will impart more energy than a short one of the same speed. The advantage of using long columns is that such columns can carry great momentum with them that can hit the working gas very hard, spiking its temperatures and pressure. This is especially true of what would be envisioned as the most efficient design of this type of engine whereby liquid metal is used as both the liquid within the control loop and the hydraulic fluid within the high-pressure piping. This serves two advantages. The liquid metal can accommodate extremely high temperatures and carries a very high mass capable of delivering a maximum compression and temperature “spike” on the working gas limited only be the materials capabilities of the high-pressure pipeline and the pressure vessel. Such high temperatures in the thousands of degrees can disassociate a working gas, for example steam into H2 and O2 and then recombine to steam, releasing heat and driving the temperature and pressure of the working gas up even higher, producing the maximum efficiency attainable from the engine, to the point whereby the heat inputted to the heating coils from a heat source can be reduced, while maintaining the cycle. A free-piston made up of a long solid column of ceramic, alloy or steel can be substituted for the liquid metal within the high-pressure piping to perform the duty of compressing the working gas, in which case, power would be extracted from the system via the working gas or via electrical generation between a conductive/magnetic design between the high-pressure piping and the piston.

The high pressure piping of the present invention can exist anywhere between an upright vertical position to a horizontal position just so long as it maintains the working gas within the pressure vessels and the hydraulic piston's integrity.

The heat exchangers/pressure vessels of the engine are very similar to shell in tube-type heat exchangers and may be substituted, as well as any suitable heat exchanging/vessel combination that allows the same type of heat transfer between a control loop and a pressurized working gas while having the working gas in communication with a hydraulic fluid for purposes of pumping the fluid.

The pressurizing pump needs to be able to seal against backflow after its has hydraulically pressurized the working gas. If a particular type of pump cannot fulfill this then a check valve, shut off valve or other means must be employed within the line to do so.

The solar collector represents just one means for heating the heating coils and any other heat source such as solar panels, nuclear, geothermal, combustion, process waste heat, warm bodies of water, waste heat from fuel cells, transformers, electric motors and combustion engines may also be used.

Heating and cooling coils are just one way of constructing a means whereby heat may be added or taken away from the control loop fluid. Other means such as passing the fluid through a porous thermally conductive media or using many of the various commercial heat exchangers may also be used.

The fan represents just one means for removing heat from the cooling coils and any other means such as refrigeration coils, evaporative cooling, natural air convection, household or city water, bodies of water, burying underground etc. may be used.

Oil was used as the fluid within the control loop although any liquid, gas, solid, slurry or combination thereof may be substituted as long as it is able to transport heat to and from the working gas of the engine for the purposes of sustaining the engine's operation.

Water and air were used in the pressure vessel and high pressure piping although any suitable combination of liquid/compressible gaseous media may be used, including the use of slurries or suspended solids within the liquid.

A barrier such as a bladder, bellow seal, diaphragm, free-piston, secondary liquid etc. may exist between the working gas and the hydraulic fluid of the high pressure piping to seal between them where contamination or incompatibility may be a concern.

A logic controller may be employed to create specialized thermal engine cycles by regulating the flow of fluid within the control loop to provide isothermal, adiabatic or other conditions for the working gas, or for creating unique power curves during the engine's power strokes in real-time. As well, the control loop may possess any necessary devices such as switches, sensors, valves, external fluid sources, heat input or output means, individual controllers for the heating and cooling coils etc. for accomplishing a particular job of managing the operation of the overall engine.

It would be preferred to have the inner walls of the pressure vessels and regenerator areas of the control loop lined with a thermally non-conductive material such as ceramic etc. so that thermal losses are minimized.

The present invention can exist on its own or as an integrated part of a larger system.

A metering pump can be used instead of a circulation pump within the control loop to provide for more accurate flow.

Instead of having twin motors on a common main line the high pressure piping may be divided right at the base of the pressure vessels into two or more separate lines to feed the hydraulic motors or other devices and/or processes individually. A single hydraulic motor may exist combined with directional flow switching valves to maintain a common directional flow through the motor regardless of the direction of flow through the high-pressure piping.

The high-pressure piping can be thermally insulated to prevent the input or loss of heat from it depending on what is advantageous for a particular application. Without insulation, a simple means to provide cooling of its high-pressure piping can be done using natural convection or conduction etc., especially on long pipe runs.

If it is desired to utilize part of the engine's heat for external use such as heating, low grade heat can be extracted at the cooling coils and high temperature heat can be extracted at the regenerator, providing enough regenerative heat is still available to sustain engine operation.

The following are several ways for carrying out refrigeration and cooling cycles within the engine:

Heat rejected from the control loop can be used to power an absorption-type refrigeration system.

During normal operation of the engine the column of hydraulic fluid moves back and forth within the high pressure piping, compressing the working gas within the pressure vessels and the heat of compression is removed each compression stroke by the heat exchangers. Each cycle we are left with relatively cool high pressure working gas alternating in each of the pressure vessels. Now during each cycle, before the control loop circulates the hot liquid from its regenerator and heating coils to the highly compressed working gas of the pressure vessels to initiate their power strokes, a portion of that working gas can be bled off for refrigeration purposes. Refrigeration piping made up of a valve, an expansion nozzle and a heat exchanger can exist straight across and mid-way between the pressure vessels. Since at the end of each power stroke we always have one pressure vessel at a higher pressure than the other we can use the lower pressure of the opposing pressure vessel as a target to exhaust the gas of the higher-pressure vessel, creating the cooling effect desired. A second nozzle and heat exchanger can exist between the pressure vessels going the opposite direction for the return power stroke, or a common nozzle and heat exchanger may be shared between the two through valve switching. This refrigeration cycle would continue back and forth between the two pressure vessels as long as the engine operates, but can be switched on or off simply by allowing or not allowing the refrigeration valves to operate. The exhausted gas within the lower pressure vessel is then simply compressed during the opposing pressure vessel's power stroke. The engine can be dedicated to the refrigeration cycle so that all of its working gas over that amount necessary to maintain operation of the engine is used for refrigeration, in which case, hydraulic motors would not be needed in the engine, or only part of it may be bled in cases where it is desired to still extract work from the hydraulic motors. The amount of working gas bled for refrigeration purposes can be up to that amount over what is needed to sustain operation of the engine, whether for supporting the refrigeration cycle only or for driving motors as well.

A second type of refrigeration cycle operates similar to the one just described, except that now we will use the liquid of the hydraulic piston to produce cooling. In this case the hydraulic fluid used for the piston must be of one suitable for refrigeration purposes such as ammonia, commercial refrigerants, butane etc., just to name a few. While at or near the end of its power stroke the hydraulic piston is under great pressure. It is here that part of it can be bled away in liquid form so that it can be expanded through an expansion nozzle and heat exchanger like in the first example, or evaporated over a heat exchanger surface and then transported over to the pressure vessel for re-introduction into the system preferably at a point of least pressure during the engine's cycle.

The heat absorbed by the working gas or hydraulic piston during these refrigeration cycles can be added to the working gas on the expansion side of the piston during engine operation to assist in providing energy to it for driving the piston or may be used externally for heating purposes etc.

One may also use a secondary liquid or gas other than that of the hydraulic piston or working gas for refrigeration purposes that can be externally introduced into the pressure vessels preferably at points of lowest operating pressure for purposes of utilizing the hydraulic piston to pressurize them for refrigeration use external to the engine such as to cool the engine heat sink or use elsewhere.

By driving the hydraulic motor(s) via an external motor drive that moves the hydraulic fluid back and forth within the high-pressure piping, compressing the working gas within the pressure vessels, the engine, now becoming a heat pump that can may produce the same refrigeration and heat-producing cycles previously mentioned. The hydraulic motors however, should be of a type such as piston, that make good pumps while operating in reverse (being driven instead of driving). If the system is dedicated as a heat pump and will never run as an engine then pumps ideally suited for this type of application can be chosen.

Up till now it has been shown how the engine can drive a generator and produce refrigeration and heating. The engine can also perform all of these functions simultaneously for tri-generation purposes.

The engine can be designed using a common media for both the hydraulic fluid of the high-pressure piping and the working gas such as liquid propane/propane gas. In this type of design, not only can the working gas be bled off to supply the high pressure/highly heated combustion fuel for providing heat to the heating coils, but provides a good refrigeration media, and makes a convenient system for residential or commercial use whereby existing propoane storage tanks can be utilized for not only providing heating, but for refrigeration, air conditioning, and electrical generating needs as well.

The engine can create specific areas of lowered pressure within its high pressure piping by having an ejector type venturi device in the line that would accelerate the hydraulic fluid or working gas, creating an area of low pressure at its nozzle, for supporting any of the forementioned processes as well as any others a designer may wish to create.

The engine can compress its working gas for external storage and future use by introducing additional compressed gas from an external source into the pressure vessel(s) preferably at the point when the working gas' pressure during its power stroke is at a minimum. By producing a rapidly moving column of hydraulic fluid within the high-pressure piping, the column of hydraulic fluid possesses momentum that will continue to compress the working gas at one pressure vessel even though the hot expanding gas at the other pressure vessel has lost much of its pressure. It is at this time that external gas may be pumped through a valve into the lower pressure vessel. When the next power stroke sends the water column back to the pressure vessel that external gas was added to, it can pump the extra added gas from that pressure vessel at a point when its pressure is at its maximum, as determined by a valve setting, through a valve for external use at a much higher pressure than when it went in. The external gas' heat of compression can be utilized by the engine for performing work just as it does for its working gas. If it is desired to use the externally pumped gas for refrigeration, then it can be expanded for such a purpose.

In a similar manner to the compressor mentioned above, the engine can be designed to pump liquids as well for purposes of propulsion, powering external hydraulic systems, providing pressurized water for reverse osmosis systems or for transporting liquids. For example, external pressurized water existing at a pressure higher than that of the working gas at its minimum power stroke pressure can be pumped during operation into the area of the engine's high pressure piping behind the water column within, preferably at the point in the engine's power stroke when the pressure vessel at that end has its pressure at a minimum. On the return stroke of the engine, prior to the water column reaching the top of the high pressure piping and being at its maximum pressure, a valve is opened along the piping allowing the volume of water originally added during a state of lower pressure, to be extracted at a much higher pressure for use such as for filling a water tower, hydraulic propulsion, utility water supply etc. An in-line flow meter can regulate the amount of water extracted before the valve is closed until the next cycle.

It is the control loop that determines the pressure, flow rate, timing etc. of the working gas and hydraulic fluid within the pressure vessels and high-pressure piping. This control loop can be designed to be variable during operation to modulate the output of the engine by having variable heat input and heat removal as well as by having the ability to speed up, slow down, or halt the flow of fluid through it at any time. For the control loop to control the engine as described in FIGS. 1-5 the volume of flow within the control loop piping from and including the heating coils to the top of either heat exchanger essentially equals the volume of flow from the top of either heat exchanger to its bottom. Likewise, the flow within the control loop piping from and including the cooling coils to the bottom of either heat exchanger essentially equals the volume of flow from the bottom of either heat exchanger to its top. This provides so that the cool water of the cooling coils never passes up into the heating coils and vice-versa during operation so that heat from the heating coils is not wasted.

However, it is up to the designer to determine the particular operation of the engine and one may decide to have half the flow volume within the control loop as that of the heat exchangers.

The engine can use a fluid exchange pump (U.S. Pat. No. 4,818,187) existing as part of the high pressure piping whereby a section of piping moves in and out of flow alignment with the hydraulic fluid flow for the purposes of introducing and removing external fluids from the piping. For example, when the power strokes minimum pressure is reached within the pressure vessels, the section of high pressure piping experiencing the minimum pressure gas can be rotated out of the pipeline and replaced with an equal volume of liquid or higher pressure gas, for the purposes of pumping the liquid or higher pressure gas from the pipeline at a higher pressure than when the return power stroke occurs.

A free piston or multiple free pistons may exist within the engine having a straight high pressure pipeline so hat the hydraulic fluid moving back and forth between the pressure vessels on each end carries the piston(s) with it. Free pistons can exist at the mid-point through the high pressure piping, at each end of the hydraulic fluid column, or can exist in large numbers throughout, just so long as they do not collide with motors, themselves or other components of the pipeline. There may be numerous small pistons or a single large piston. These pistons can have spacers in-between them so that they maintain their distance between each other. They can be provided with seals between them and the piping walls to better catch the flowing fluid or ride on bearing surfaces to reduce friction and pipe wall wear. They may be elliptical riding within an elliptical cross-sectional pipe to increase bearing surface area. They can be made of any suitable material and offer the advantage of providing added momentum to the engine's power stroke when heavy materials are used. They also can produce electricity by making them out of copper or some other conductive material while lining the pipeline with electro or permanent magnets or vice-versa, with electrical leads connected to the piping to transfer the AC or DC externally. In a reverse fashion, current can be applied to the electro-magnets to impart movement in the pistons for pumping purposes. The spacing of multiple pistons can produce a particular frequency as they flow through the high-pressure piping, dependent on their spacing and velocity.

The present invention may be utilized in the magneto hydraulic production of electricity whereby a conductive liquid such as liquid metal, seawater etc. is passed through a MHD generator within the high-pressure pipeline, while electrical leads are connected to the generator to extract current for external use.

The engine may incorporate a double-acting piston connected to a flywheel and external shaft on a single straight length of high pressure piping to replace both hydraulic motors, valves and split piping mid-point through the high pressure hydraulic piping of FIGS. 1-5, so that the top of the piston is exposed to the hydraulic fluid of pressure vessel #1 and the bottom of the piston is exposed to the hydraulic fluid of pressure vessel #2. When higher pressure exists in pressure vessel #1 and lower pressure exists in pressure vessel #2, the higher pressure pushes against the top of the piston, driving it to the right, and when the higher pressure exists in pressure vessel #2 and lower pressure exists in pressure vessel #1, the higher pressure pushes against the bottom of the piston, driving it to the left. This force is in-turn translated to the flywheel to smooth out operation and then outputted to the external shaft for use. The volume flow of hydraulic fluid through the high-pressure piping of the engine is limited to the volume of each stroke of the piston. The piston in this example can be replaced with any number of conventional or innovative hydraulic motor arrangements sand is an attractive design for small engines that cannot accommodate long hydraulic piping circuits.

By controlling the speed of water column in the high pressure piping, the HOC temperature can be controlled so that an optimum delta T can be maintained between the working gas and the surrounding control loop heat transfer media designed to absorb it.

The engine can operate using only a moderate temperature heat source, in which case the engine's HOC' temperature may exceed that of the heat source's in which case, after the working gas is compressed within the pressure vessels, the control loop will circulate to enable the heat from the heat source to flow through the heat exchangers of the pressure vessels prior to the regenerative heat.

The control loop can use evaporative cooling or its heat to operate an absorption refrigeration system to further cool its heat sink temperature. By using a liquid suitable for refrigeration within the control loop, evaporative cooling can be used for removing heat from the working gas by passing the liquid refrigerant over a heat exchanging surface, causing evaporation to occur and the removal of heat.

The HOC removed from one pressure vessel's working gas during its compression can be added to the already expanding working of the other pressure vessel to provide additional heat. This can be done by providing that the control loop directs the flow of HOC removed from the first pressure vessel to the second during this part of the cycle. On the return, the opposite can occur as the HOC from the second pressure vessel is directed to the first during its expansion.

An advantage of the control loop having its heat transfer media in indirect contact with working fluid is that the control loop pressure can remain at low pressure and large inexpensive heat exchangers can be used made of plastic, inexpensive steel, rubber hose etc.

The engine's versatility allows it to take on may forms including using the tubular frames of vehicles and equipment or flexible hose to function as the high pressure piping and control loops of the engine.

As mentioned earlier, since the present invention can produce high grade heat from low grade heat using the working gas' HOC generated, and the overal engine efficiency rises as one increases the difference in temperatures between the engine highest and lowest temperatures, then in situations when only a moderate temperature heat source is available we can utilize the high temperatures produced by the engine cycle's HOC to become our max system temperature instead of the lower temperature heat source. This allows us to discard heat at high temperature differentials to the engine's heat sink. The moderate temperature heat from the heat source can then be utilized for providing that heat back to the high pressure working gas that was originally removed in order for it to expand and perform work to sustain the continued operation of the engine. If no work is extracted from the engine and it is simply allowed to rise in temperature and pressure to its maximum operating capabilities, then this would become its maximum operating efficiency. The control loop of the engine can modulate the performance of the engine so that the engine can deliver what is needed at a particular time such as running for peak work output, or running for peak efficiency, or somewhere inbetween.

Depending on the power stroke of a particular motor used such as piston, rotary etc., will determine whether heat is inputted during expansion all initially or spread out over the course of the expansion so that it is either carnot (isothermal/adiabatic), isothermal, or even something custom such as high initial power output with tapering power at end of stroke.

One advantage to having a closed system control loop is that it allows the loop to run at high pressure, equal to that of the high pressure working gas enabling thin-walled heat exchangers to be used, facilitating quick and easy heat transfer. A high pressure control loop also suppresses the vaporization of liquid thermal transfer medias that may be used within the loop.

The high pressure working gas within the high pressure piping helps to suppress the vaporization of the hydraulic piston during operation, even at high temperatures well above their ambient boiling points.

The high pressure piping can be pre-pressurize with chemical reactions, hydraulic head etc.

The control loop's thermal transfer media may include a steel ring that can be heated on one side and cooled on the other that as it rotates, moves in an out of heat exchanging contact with the high pressure working gas of the pressure vessels. Similarly, using a metal chain or similar flexible solid rolling through the pressure vessels can also function as a thermal transfer media. Ball bearings flowing down through heat exchanger coils is still another possibility.

As mentioned earlier using the engine's HOC to increase the operating temperature of the engine to its maximum performance capabilities, during this ramp-up time, no heat is needed to be rejected simply because for short running duration, it is not necessary to have heat dissipation due to the fact that there will temporarily exist a temperature differential between the high pressure working gas of the two pressure vessels allowing cycling to occur between them until their temperatures balance, at which time the engine will no longer cycle.

The modulation of the engine must be managed by logic controllers as commonly used by HVAC systems.

The temp rise of the gas being compressed depends on several factors such as gas density (initial pressure), piston speed, heat sink temp, density & capacity, set temp of heat extraction etc. as is well know to those versed in thermodynamics.

Some of the factors a designer must consider in the design of the engine's control loop depending on its application are as follows: The space available; whether the primary use of the engine is for hydraulic work, heating, cooling or as a heat source for another engine; the pressure and temperature capabilities of the materials used; the heat sink available; what the waste heat will be used for; the distance between the pressure vessels; the type of heat source; the cycle rate desired; the power output/performance desired.

The engine's temperature control system would have to sense the temperature within the working gas and thermal transfer media within the control loop to then regulate the volume flow of thermal transfer media within the control loop to maintain the temperature of the working gas by opening or closing a valve until the set temperature is maintained.

Another factor a designer must take into consideration when designing the present invention is the thermal transfer rate of the heat exchangers when timing the cycling of the engine.

The flow of the hot and cool liquid within the control loop and heat exchangers that subsequently controls the input and removal of heat to the working gas is fully regulated in both directions via the circulation pump, enabling it to speed up, slow down or dwell. This allows for real-time modulation of the engine's compression and power stroke to create an isothermal, adiabatic, or any other condition within the gas, producing any desired power curve or cycle, including the Carnot cycle.

The embodiment depicted in this application is shown only for the purposes of illustrating the operation of the engine as it pertains to producing power. As with any technology, different applications and varying requirements can cause the engine to take on many different forms and functions and although it would be impossible to capture all of the present and future design options necessary to meet these various applications and requirements, a partial list was provided here for reference. Obviously those skilled and knowledgeable in the art of heat engines, HVAC systems and controls and hydraulics will already have a good foundation for its design.

1. A heat engine comprising:
a piston means;
a high pressure piping means wherein said piston is moveably positioned, having a pressure vessel positioned and terminating said high pressure piping means at each end and at least partially filled with a high pressure working gas on both sides of said piston means so that as said piston means travels through said high pressure piping means it compresses the high pressure working gas ahead of it and expands the high pressure working gas behind it;
a heat source means isolated from said high pressure working gas, who's purposes it is to add heat to it only on one side of said piston means at a time for the purpose of expanding said high pressure working gas and driving said piston means through said high pressure piping means to perform work;
a regenerator means isolated from said high pressure working gas, who's purposes it is to remove heat of compression from it during its compression from the side of said piston means opposite that which is having heat added, for the purpose of reducing the amount of work necessary by said piston means to compress it, and which upon completion of compression, can return at least a part of said heat removed to the same compressed gas for the purpose of expanding it and driving said piston means through said high pressure piping means in the opposite direction to perform work;
a heat sink means isolated from said high pressure working gas, who's purposes it is to remove heat from it after work has been performed;
a control loop means having a transportable heat exchanging media and means for transporting it, physically isolated from said high pressure working gas; heat exchanger means positioned at least at each pressure vessel, heat source means and heat sink means so that said transportable heat exchanging media can communicate with them for the purposes of exchanging heat with their suroundings, a heat storage means comprising at least one length of path along which said transportable heat exchanging media will travel to and from removing and returning said heat of compression whereby said transportable heat exchanging media may temporarily reside with minimal heat loss; so that as the overall control loop system transports heat from said heat source means to said high pressure working gas on one side of said piston means, it is able to remove compressive heat from said high pressure working gas on its other side and temporarily store it until a time when said high pressure working gas is fully compressed, at which point said transportable heat exchanging media can return at least a portion of said heat removed to the compressed high pressure working gas; and it can transport heat from said high pressure working gas to said heat sink means so that the engine can sustain continuous operation to perform work.
